(19) United States
(12) Patent Application Publication
(10) Pub. No.: US 2015/0100594 A1
(43) Pub. Date: Apr. 9, 2015

(54) SYSTEM AND METHOD FOR FINANCIAL RESEARCH MANAGEMENT

(71) Applicants: Patrick J. Hess, North Oaks, MN (US); Huigang Zuo, Eden Prairie, MN (US)

(72) Inventors: Patrick J. Hess, North Oaks, MN (US); Huigang Zuo, Eden Prairie, MN (US)

(21) Appl. No.: 14/501,316

(22) Filed: Sep. 30, 2014

Related U.S. Application Data
(60) Provisional application No. 61/886,263, filed on Oct. 3, 2013.

(51) Int. Cl. G06F 17/30

(52) U.S. Cl. CPC G06F 17/30076
USPC 707/755

(57) ABSTRACT

Systems and methods are provided to enable robust content-based database storage, searching, retrieval, analysis, processing, and collaboration. According to one embodiment of the invention, a system and method are provided for facilitating data management and analysis in connection with financial data.

### FIELD OF THE INVENTION

The present invention relates generally to computer systems and more particularly relates to a method and system for advanced data management and analysis.

### BACKGROUND OF THE INVENTION

Financial decision-makers, such as traders, investment bankers, researchers, and other financial professionals, rely on information from wide-ranging and varied sources. In order to make wise, informed investment decisions investors need access to investment research, news feeds, stock quotes, and U.S. Securities and Exchange Commission (SEC) disclosures such as SEC Form-10K, Form 10-Q, Form S-1, proxy statements, and other public and private company disclosures.

To facilitate manageable access to such information about such markets, many firms create and maintain databases with historical financial data. The data may be supplemented with subscription or public data from firms such as Bloomberg, CNBC, FINVIZ, NASDAQ, SeekingAlpha, StreetInsider, Morningstar, Hoovers, Thomson Financial, Standard & Poor's, and Reuters, which provide their users with access to commercial databases over the Internet. Moreover, investment professionals responsible for analyzing a particular company or industry sector also may receive thousands of individual information items per day. While some of the information items may be logically categorized, well-formatted, and structured when they are sourced from certain sources, other information items may not retain suitable formatting during conversion into a local system or may be informal documents that are not structured or cannot be easily cited during subsequent analysis. Moreover, existing systems have not effectively adapted to the higher volumes of information available for analysis from sources such as the Internet, the speed at which it is delivered, and the varying formats in which it is delivered.

Current software solutions are limited in that they do not provide users with transparency between source documents and analysis based on such source documents. Moreover, current solutions do not organize source documents and other data in a manner that effectively reflects information dependencies. Finally, currently available client-side software does not offer intuitive research tools that integrate seamlessly into a collaborative research environment.

### SUMMARY OF THE INVENTION

Systems and methods are provided to enable robust content-based database storage, searching, retrieval, analysis, processing, and collaboration. According to one embodiment of the invention, a system and method are provided for facilitating data management and analysis in connection with financial data.

### BRIEF DESCRIPTION OF THE DRAWINGS

FIG. 1 is a block diagram of an embodiment of an information management and analysis system according to an embodiment of the invention;

FIG. 2 is a block diagram of an embodiment of a server comprising multiple networked components of the information management and analysis system according to an embodiment of the invention;

FIG. 3 is a flow chart illustrating the data flow process of importing a file into the information management and analysis system according to an embodiment of the invention;

FIGS. 4A-4B are flow charts illustrating the data flow process of creating a research document in the information management and analysis system according to an embodiment of the invention;

FIG. 5 is a block diagram of an embodiment of multiple clients accessing multiple networked components of the information management and analysis system according to the invention;

FIGS. 5A and 5B are flow charts illustrating the operational process of a user session with the information management and analysis system according to the embodiment of the invention in FIG. 5;

FIG. 6 is a screen display of a user interface on a client device in an embodiment according to the invention;

FIG. 7 is a screen display of a user interface on a client device in an embodiment according to the invention;

FIG. 8A is a screen display of a user interface on a client device displaying an XBRL data selection prompt and a spreadsheet in an embodiment according to the invention;

FIG. 8B is a screen display of a user interface on a client device displaying an XBRL data selection prompt and a spreadsheet in an embodiment according to the invention;

FIG. 9 is a screen display of a user interface on a client device displaying an XBRL data item selection module in an embodiment according to the invention;

FIG. 10A is a screen display of a user interface on a client device displaying table data from a PDF document in an embodiment according to the invention;

FIG. 10B is a screen display of a user interface on a client device displaying table data pasted into a spreadsheet;

FIG. 11A is a screen display of a user interface on a client device displaying table data from a HTML document in an embodiment according to the invention;

FIG. 11B is a screen display of a user interface on a client device displaying table data pasted into a spreadsheet;

FIG. 12 is a screen display of a user interface on a client device displaying a spreadsheet toolbox in an embodiment according to the invention;

FIGS. 13 and 14 are screen displays of a user interface on a client device displaying label toolboxes in an embodiment according to the invention;

FIG. 15 is a screen display of a user interface on a client device displaying a research document and a source document in an embodiment according to the invention;

FIG. 16 is a screen display of a user interface on a client device displaying research document containing a link in an embodiment according to the invention;

FIG. 17 is a screen display of a user interface on a client device displaying a spreadsheet containing a link in an embodiment according to the invention;

FIG. 18 is a screen display of a user interface on a client device displaying a spreadsheet containing links in an embodiment according to the invention; and

FIGS. 19A and 19B are screen displays of a user interface on a client device displaying a spreadsheet and a hyperlink tool in an embodiment according to the invention.

### DETAILED DESCRIPTION OF THE INVENTION

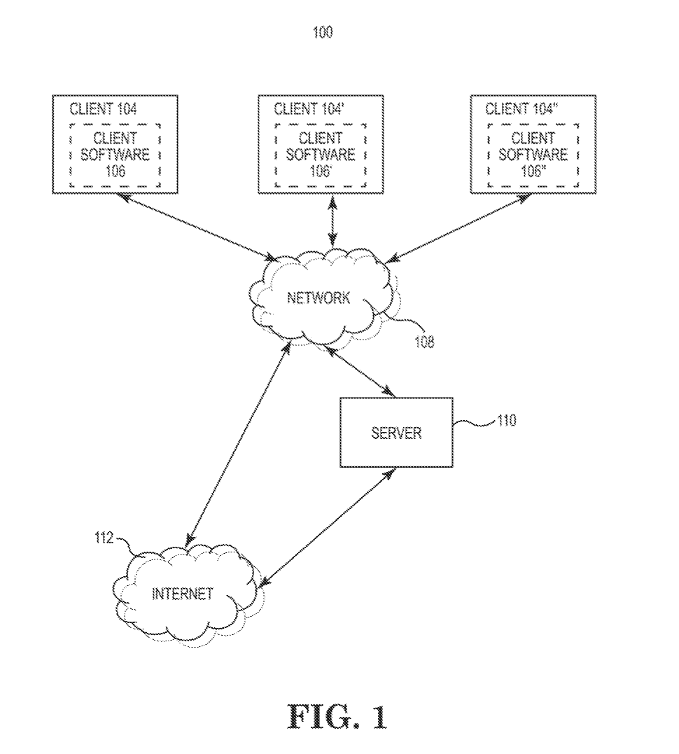

Referring to FIG. 1, in one embodiment an information management and analysis system 100 includes at least one server 110, and at least one client 104, 104′, 104″, generally 104. As shown, the information management and analysis system 100 includes three clients 104, 104′, 104″, but an information management and analysis system 100 in accordance with the invention may include any number of clients 104. Client 104 may be implemented as software running on a personal computer or on hardware such as a dumb terminal, network computer, wireless or other mobile device such as a smart phone or tablet, information appliance, workstation, minicomputer, mainframe computer, or other computing device that is operated as a general purpose computer or a special purpose hardware device solely used for serving as a client 104 in the information management and analysis system 100.

In various embodiments, the client computer 104 includes client software 106. In one embodiment, client software 106, executing on the client 104, opens a network connection to the server 110 and Internet 112 over the communications network 108 and communicates via that connection to the server 110 and the Internet 112. The type of network 108 and the communications protocols employed by the network are not limited, and a variety of suitable options are available. In one embodiment, communications network 108 may connect the client 104 with the server 110 and Internet 112 via any link such as standard telephone lines, local-area network or wide-area network (LAN or WAN) links (e.g., T1, T3, 56 kb, X.25), broadband connections (ISDN, Frame Relay, ATM), and wireless or wired ethernet-based intranet, and network 108 may carry TCP/IP protocol communications, and HTTP/HTTPS requests made by the client software 106 and the connection between the client software 120 and the server 110 can be communicated over such TCP/IP networks.

One example of client software 106 is an application such as a web browser that allows the client 104 to request a document file (e.g., from server 110 or Internet 112) by transmitting a document request. Clients 104 may be operated by users of the system to retrieve and review information and to create and share research and analysis documents. Examples of requested document files include data files, HTML files, XBRL files, PDF files, files in Microsoft Office format offered by Microsoft Corporation of Redmond, Wash., and CSV and other text-related formats, which can be stored and managed in accordance with this invention. In one embodiment, a user of the client 104 manually requests a web page from the server 110. Alternatively, the client 104 automatically makes requests for web pages using the web browser. The web browser is just one possible example of client software 106, and others may include desktop applications, word processors, spreadsheets, operating system extensions, email clients, as well as others.

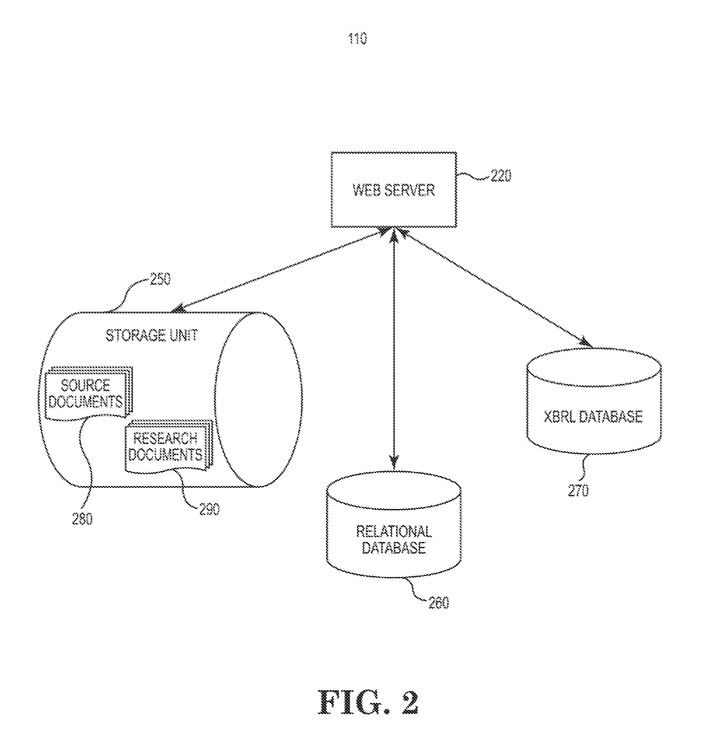

Server 110 may be a single component, with both processing and storage capabilities, or a collection of networked devices. Referring to FIG. 2, in one embodiment, server 110 includes a web server 220 providing an operating system, programming language execution environment, and a database. Web server 220 may provide such functionality through physical or virtual machines or other computer processing resources and may be hosted onsite or remotely, such as through an Infrastructure as a Service (IaaS) or Platform as a Service (PaaS) offering. Server 110 includes a storage unit 250, which may be located remotely, such as an enterprise-level cloud data storage or a consumer-level file hosting service, or storage unit 250 may be arranged proximate to web server 220 as onsite storage. Storage unit 250 may be any suitable computer-readable storage medium, such as a disk drive, flash memory, digital versatile disks (DVDs), compact disks (CDs), and other types of storage and recording mediums. Examples of cloud computing data storage services that are suitable for storage unit 250 include Google Drive, Dropbox, Microsoft SkyDrive, and Apple iCloud, but a variety of other storage services may be used as well. Storage unit 250 stores source documents 280 and research documents 290 and may retain other digital data consistent with the operation of the information management and analysis system. Server 110 includes relational database 260 for storing and organizing various data such as metadata pertaining to source documents 280 and research documents 290, including links and pointers relevant to specific information in the documents or data logs that record document views, searches, and comments by system users. Other suitable database or table structures may be employed instead of or in addition to relational database 260. In one embodiment, server 110 may also include and XBRL (eXtensible Business Reporting Language) database 270 for storing and organizing business information, such as corporate reporting data from the Securities and Exchange Commission (SEC) or the HM Revenue & Customs (HMRC). Web server 220 is in communication with storage unit 250, relational database 260, and XBRL database 270 through network connections or other suitable means. Information management and analysis system 100 is configured to provide researchers and analysts with live data, which facilitates real-time and immediate analysis, and web server 220 may be in communication with other data sources and components to retrieve additional data and information as appropriate.

A system user may import any suitable external document into information management and analysis system 100 through a variety of methods. For example, a user may identify an external file, such as a document that is not currently in the system, download the file from a remote location including internet 112 or another remote server, and import the document into storage unit 250. In another example, the system user may identify a local file on the user's client computer 104 and upload the file into storage unit 250. In yet another example, web server 220 automatically receives data from a predetermined RSS feed, or other suitable newsfeed, and imports and saves such data in storage unit 250 as source documents 280.

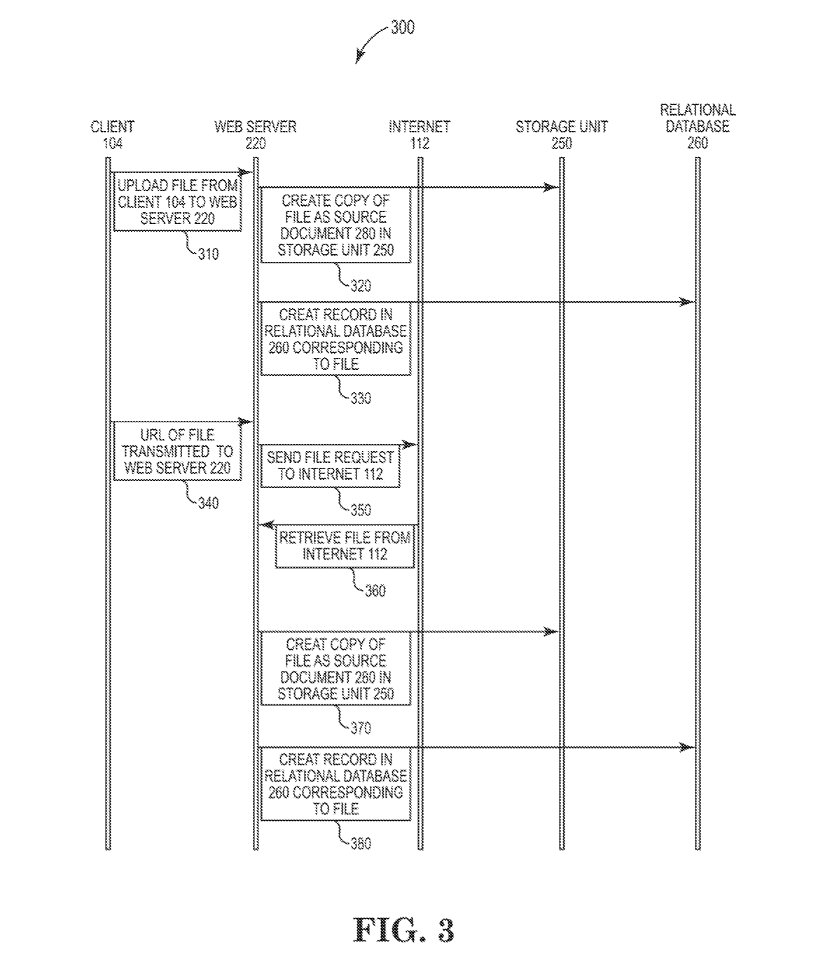

Referring to FIG. 3, a process 300 is shown whereby information management and analysis system 100 imports an external file into the system by uploading and processing the file and then storing the document in storage unit 250 as a source document 280. In one example, the subject file is stored locally on a user's client computer 104, or on a network drive mapped to client computer 104. At step 310, the user locates the local file and instructs system 100 to upload the file from client 104 to web server 220. The file can be any suitable file type or format, such as files in Microsoft Office format, PDF files, HTML files, XML files, text files, CSV and other text-related formats, and the like. After system 100 uploads the local file, the system converts the file into a suitable format, such as HTML, and creates a copy of the converted file in storage unit 250 at step 320. At step 330, system 100 also creates a record in relational database 260 corresponding to the source document 280 that was created in step 320. Additional processing of the uploaded file may also be performed, as described below, and further metadata pertaining to the file may be entered into the record of relational database 260 that corresponds to the source document 280. When the source document 280 is generated in the system, the subject file imported by the user may be converted into another format suitable for subsequent use. In one embodiment, subject files are converted into HTML format either at the time the files are imported or, in some cases, after the files are imported and only when a file is being analyzed by a user who performs specific actions, such as highlighting a table or other text in that file. For example, if a user imports an external file in PDF format, the step 320 of creating a copy of the file in storage unit 250 may include a conversion process from PDF format to HTML. In other examples, the external file is merely imported in its native format during step 320, but the external file is not converted until a subsequent action occurs, for example a user highlights a table or other text in the file. Responsive to such action, the system converts the file into HTML format.

In another example, the external file is located on internet 112, or another remote server, and the system downloads and then imports the file. The system may already have the corresponding URL, or web address, of the file's location stored in local memory or other local storage at client 104, or the URL may be stored elsewhere on the system, such as on web server 220. The system may retrieve the file as a one-time action or as a recurring, automated process for one or more files. If the URL is stored locally at client 104, in step 340 the client 104 transmits the URL to web server 220. Alternatively, the user may provide the URL corresponding to the file. If the URL is provided by the user, in step 340 the user may enter or paste the URL at client 104, which is then transmitted to web server 220. At step 350, web server 220 uses its network connection to send a request for the file to the internet server designated by the URL. At step 360, web server 220 retrieves the file from internet 112 at the corresponding URL. After the web server retrieves the file from the internet, the system creates a copy of the file in storage unit 250 at step 370. At step 380, system 100 also creates a record in relational database 260 corresponding to the source document 280 that was created in step 370. Additional processing of the uploaded file may also be performed, as described below, and further metadata regarding the file may be entered into the record of relational database 260 that pertains to the source document 280.

The system enables users to perform research and analysis on specific source documents that are housed in storage unit 250 by the creation of research documents from source documents. A research document may be created by a user by converting a source document into a research document, or alternatively, a research document may be created by converting an object, such as a table, from a source document into a research document. Research documents can be a variety of document types, such as spreadsheets or discussions documents, as suitable for the users' research objectives and that allows multiple users to share comments and analysis with each other. A system user has access to any source documents in storage unit 250 for which such user has permissions, and the user may continue to upload additional source documents into storage unit 250 through upload process 300. Users with appropriate permissions may edit research documents, for example by adding notes to the research documents or creating links in the research documents that associate the user-generated notes with source documents.

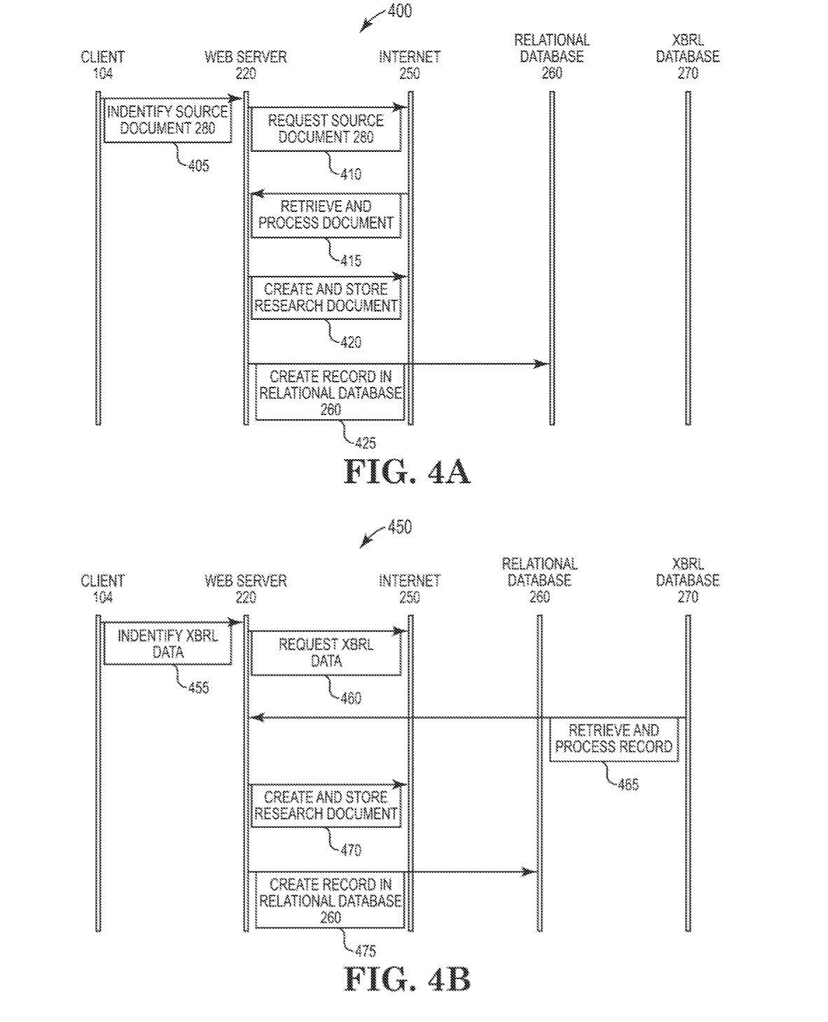

Referring to FIG. 4A, process 400 is shown for creating a research document 290 in the system. At step 405, a user at client 104 identifies a source document 280 in storage unit 250 to web server 220. At step 410, web server 220 requests the identified source document from storage unit 250. At step 415, the requested source document is retrieved from storage unit 250 by web server 220 and then read and processed. During the processing, web server 220 determines the document type (e.g., Microsoft Office format, PDF files, HTML files, text files, CSV, spreadsheets, and the like) and analyzes the document for data and formatting. If the document contains specific objects, such as tables, the web server will analyze the contents as described further herein. Similarly, if the document was created with a specific language, such as XML, the web server will parse the contents using the appropriate rules. The system can be configured to recognize and suitably process a variety of file formats and contents specific to the subject matter being researched. Once the retrieved document has been processed, a corresponding research document 290 version is created and stored in storage unit 250, step 420, and a corresponding record is entered into relational database 260, step 425, for storing and structuring relevant research information of the created research document 290. As described in more detail herein, the research information stored in the corresponding record in relational database 260 includes a variety of markings inserted into the research document 290 by users while analyzing the document. Creating the research document 290 from a source document and storing the research document 290, step 420, may be fully automated by the system or may be a facilitated process, whereby the system assists the user with converting the source document into a research document; for example, the source document may contain an object such as a table for which the system provides the user tools to allow for efficient conversion into a research document, as described further below.

In another example, a source document or research document is created from documents or records in XBRL database 270 or other suitable XBRL data such as an XBRL instance document. In one embodiment, XBRL database 270 is shared across all system users or all users in a single enterprise or, in some configurations, across multiple enterprises. Though the invention is suitable for performing research and analysis relating to a variety of subject matters, it is well-suited for financial analysis. In one embodiment, XBRL database 270 houses any available XBRL business reporting data, such as corporate SEC 10-K and 10-Q filings for the approximately 5,000 publicly traded companies in the United States of America, which may comprise approximately 30,000 data files or records in XBRL database 270. The system maintains a metadata repository in XBRL database 270 by regularly accessing the SEC site for XBRL data retrieval and updating the XBRL database 270 with live data. If the system recognizes the corporate entity corresponding to the retrieved XBRL data, the system adds the data to its records for that entity. If the system does not recognize the corporate entity corresponding to the retrieved XBRL data, the system creates a new entry in XBRL database 270 for the new entity and adds the data to its records for that entity.

Referring to FIG. 4B, process 450 is shown for creating a research document 290 from records in XBRL database 270. At step 455, a user at client 104 identifies records in XBRL database 270 to web server 220. The identified records may be any number of XBRL data, including corporate SEC 10-K and 10-Q filings. For example, the identified record may be the 2013 10-K Annual Report filed by Amazon.com, Inc. (Ticker Symbol: AMZN) with the SEC. The user interface provided by the system at client 104 allows the user to perform the data selection of step 455 by viewing and selecting specific objects or data items from multiple documents with a few clicks. For example, the user interface allows the user to select tables from multiple 10-K and 10-Q filings for AMZN, or other specified companies, with a single click and select action. The user interface provided by the system at client 104 also allows the user to perform the data selection of step 455 by designating a desired time frame and frequency of the selected documents. For example, the user may select all corporate filings by AMZN with the SEC on an annual, quarterly, or semiannually, basis, or for a user-defined period such as nine months, with a single click and select action.

At step 460, web server 220 requests the identified records from XBRL database 270. At step 465, the requested XBRL records are retrieved from XBRL database 270 by web server 220, read and processed, and displayed to the user. During the processing, the retrieved records, such as SEC 10-K and 10-Q XBRL filings, are translated and normalized to ensure consistent naming conventions and data comparison. For example, a corporate entity may change naming constructs used in its reporting, such as changing “Sales” data to “Sales Revenue Net” data, and the system normalizes this data by retrieving data from both naming constructs and including them both for sales data. Once the retrieved XBRL records have been processed, a corresponding research document 290 is created and stored in storage unit 250, step 470, and a corresponding record is entered into relational database 260, step 475, for storing and structuring relevant research information of the created research document 290.

When the user selects a specific objects or data items from the XBRL database 270, such as tables, during step 455, the system provides the user with spreadsheet tools to allow efficient copying and accurate formatting and adjustments of data and text tables with minimal user clicks and actions, and then copies the data or text tables and pastes the corresponding data into a spreadsheet research document 290, while maintaining the formatting and adjustments, during step 470. For example, the system is configured to recognize table objects in a variety of source types (e.g., PDF files, HTML files, XBRL data, etc.), such that web server 220 analyzes and reorganizes the data or text tables from the source document 280 or XBRL data 270 and pastes the live data into spreadsheet/research document 290. A corresponding link entry, such as a hyperlink or other pointer, is simultaneously created in relational database 260 that correlates the created spreadsheet/research document 290 with the precise location in the source document 280 or XBRL data 270 from which the original data or text table was derived. The link entry is created with sufficient precision that a user who subsequently views the created spreadsheet/research document 290 may readily determine and view the precise location within the source document 280 or XBRL data 270 from which the original data or text table was derived by simply selecting, highlighting, or hovering over the spreadsheet, or a specific entry or word/number in the spreadsheet, responsive to which the system will retrieve and display to the user the originating source document 280 or XBRL data 270 based on the link entry in relational database 260.

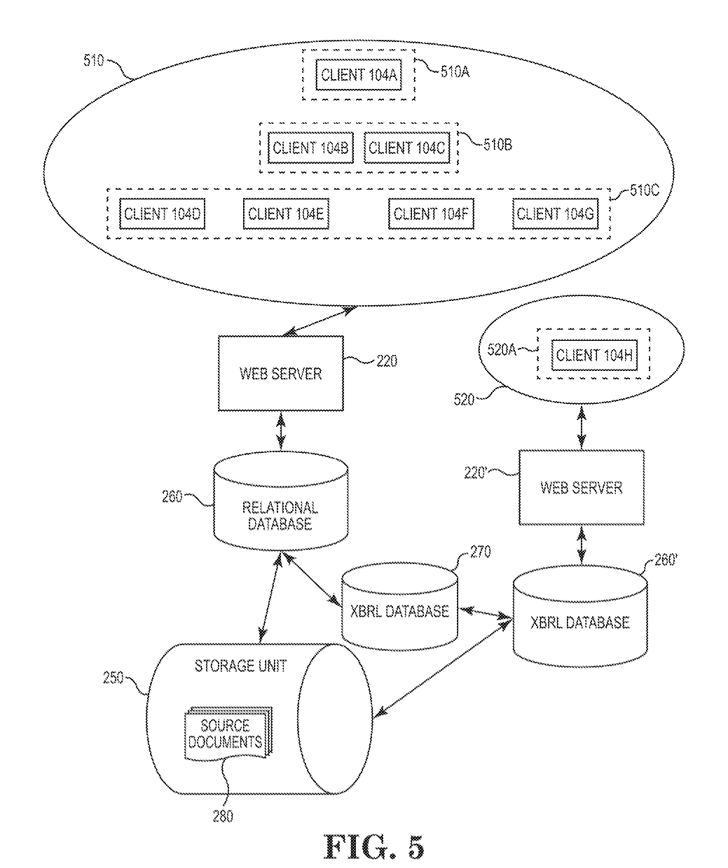

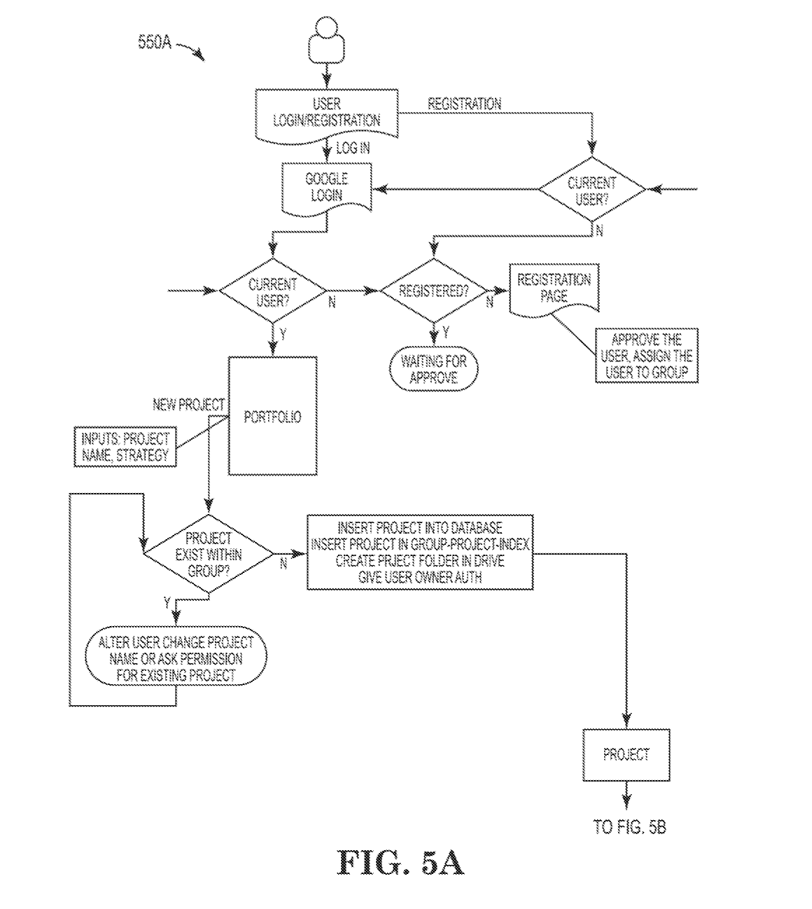

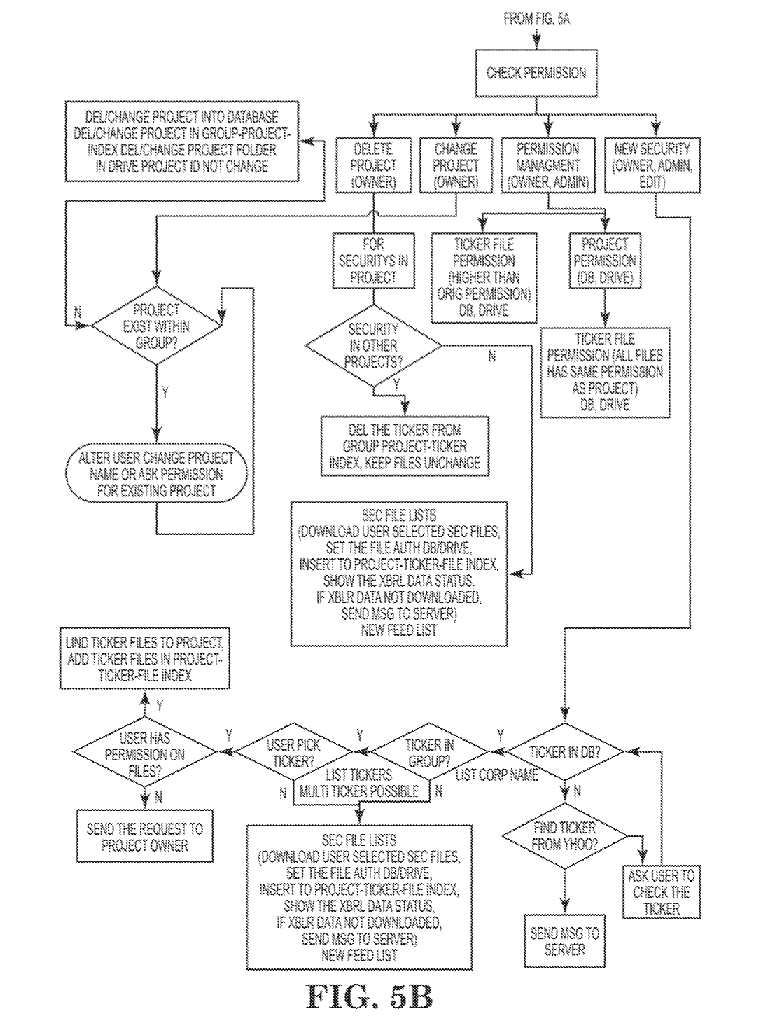

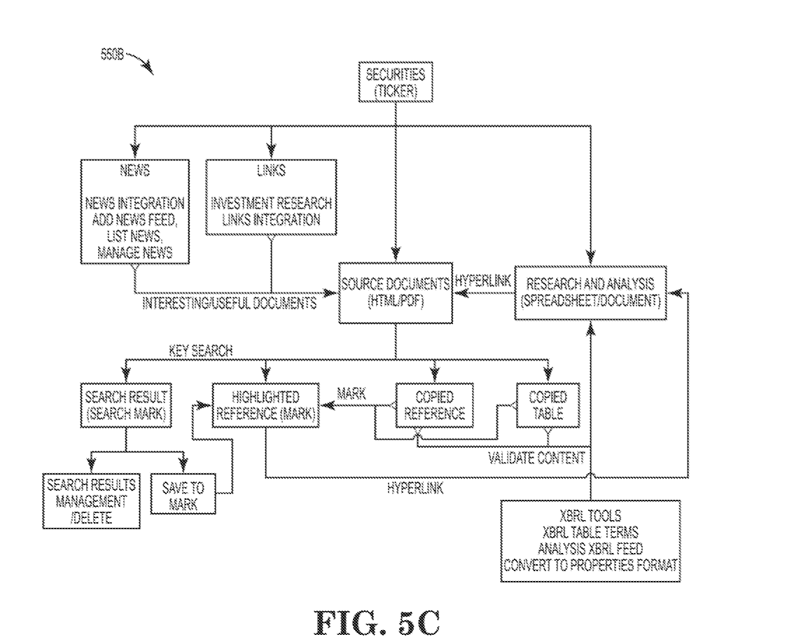

Multiple users may employ the system to collaborate and perform research and analysis as described herein. The system may be configured to allow all users on a client 104 to access and share a common relational database 260, storage unit 250, and/or XBRL database 270. Alternatively, the system may be configured for specified users to access dedicated network components for some or all of these devices. Referring to FIG. 5, in one configuration a research team 510, using client devices 104A-104G, comprises a portfolio manager 510A, senior analysts 510B, and junior analysts 510C. The team members may be granted any variation of appropriate authorization and permissions; for example, junior analysts 510C only may have rights to import source documents 280 into storage unit 250, senior analysts 510B may have permissions to import source documents 280 into storage unit 250 and to create source documents, such as spreadsheets and discussions documents with notes and comments, in storage unit 250 and relational database 260, and portfolio manager 510A may have all of the foregoing rights and additional edit and administrative rights. Alternatively, other authorization and permission schemes may be employed in accordance with the system of the present invention; for example, user authorizations to source documents and research documents may be structured by portfolio, by project, by group, by user, by document or file, or by any other suitable construct.

In this example, the junior analysts 510C locate and import relevant source documents for the senior analysts 510B to review. The senior analysts 510B research and examine the source documents and, from time to time, import additional relevant source documents not already in the system, and then create spreadsheets and discussion documents 290 indicating the research performed and conclusions reached by the senior analysts for the portfolio manager's 510A review and recommendation. In one embodiment, storage unit 250 and XBRL database 270 only contain publicly available data and information, but relational database 260 houses proprietary research of research team 510 accesses.

The system may be configured to reach the appropriate balance of security on the one hand and resource conservation and sharing on the other. For example, to optimize storage and processing efficiencies, storage unit 250 and XBRL database 270 are shared with other teams, e.g., research team 510 and research team 520, including portfolio manager 520A using client 104H, share storage unit 250 and XBRL database 270, but research team 520 maintains or leases its own separate and restricted-access web server 220′ and relational database 260′ to store its proprietary research such as results of users' analysis of source documents, spreadsheets, and discussions documents. In this example, storage unit 250 and XBRL database 270 are maintained on unsecure servers but web servers 220 and 220′ and relational databases 260 and 260′ are maintained on secure servers. The system is configurable to provide a defined research team with transparency between source documents 280 and the analysis performed by the team members stored in research documents 290. For example, the members of research team 510 (comprising portfolio manager 510A, senior analysts 510B, and junior analysts 510C, using client devices 104A-104G) may perform various, complimentary tasks in the system, such as searching, importing, and commenting upon various documents, and relational database 260 stores numerous aspects of each user's research and analysis sessions. Relational database 260 stores (i) the results of the users' analysis of source documents 280, (ii) search results of users' source document searches, (iii) catalogue of search results with precise document location links to specific portion of source documents viewed and annotated by users, (iv) precise document location links to multiple users' discussion documents and research documents 290, and (v) results of text and tables copied from source documents 280 and XBRL records 270 with document links pointing to the precise location in the referenced document or record.

In this example, a user may create a research document 290 by copying an object or table from a source document 280 or XBRL record 270 into a research document. The system automatically tracks the user's research activities and creates a link, stored in relational database 260, from the research document that points to the specific location in the originating source document 280 or XBRL record 270. Similarly, a user may view one or more source documents and create analysis notes, discussion, or conclusions in a separate discussion or research document 290 based those source documents; the system automatically and/or manually create links, which are stored in relational database 260, between the comments in the discussion/research document 290 and the specific locations in the source document(s) 280 that contain the information or data that was relied upon by the user in support of the user's discussion or conclusions. Any subsequent user, including any member of the research team with proper permissions, who is viewing the research document 290 may open the originating source document with a single click of the research document, in response to which the system will open and display the originating document to the specific location of the object or table. For example, if a user is viewing a spreadsheet research document, with a single click on the document, the system will respond by opening and displaying the source document 280 or XBRL record 270 that contains the table from which the spreadsheet source document was created or copied. Similarly, a user may view a discussion/research document 290, which contains one or more user's comments, discussion, and analysis, and responsive to a single click on the user's discussion in the document, the system will respond by opening the source document 280 to the specific location that contains the information or data was relied upon in support of the user's discussion or conclusions. The foregoing configuration and permissions allows full transparency of all collaborators in a research team.

In operation, information management and analysis system 100 is suitable for performing management and analysis relating to a variety of subject matters. For example, the system is well-suited for management and analysis of financial information, but it may also be employed for a variety of fields, such as medical research, clinical research, and other forms of scientific research, political and social research, market and consumer-based research, and the like. The following description discloses one embodiment where the system is employed for management and analysis of financial information, but that subject matter is merely illustrative, and those skilled in the art will appreciate that researchers may implement and operate the system for other subject matters as well, using the system functionality as described herein. Referring to FIGS. 5A and 5B, information management and analysis system 100 may be configured to follow operational processes 550A and 550B for defining a user session with the system in accordance with one possible configuration. FIGS. 5A and 5B refer to the “Project,” but in the context of the system facilitating data management and analysis in connection with financial data, the term “project” may refer to a “portfolio,” and the terms “project” and “portfolio” may be used interchangeably.

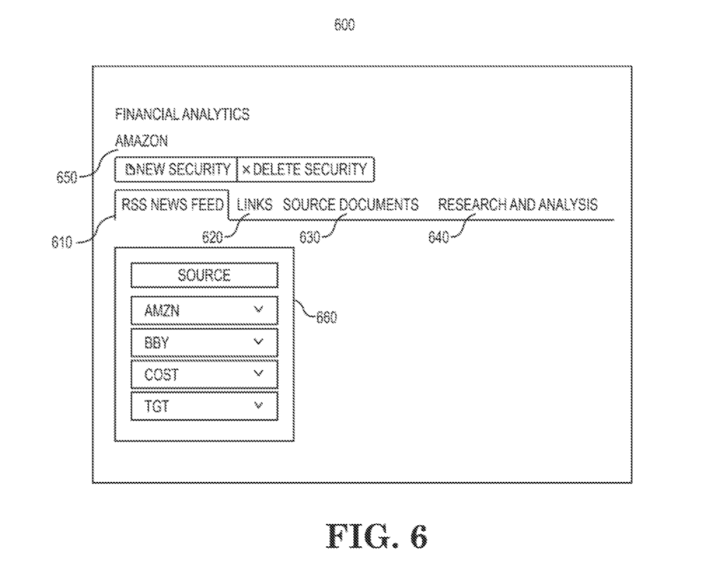

FIGS. 6-19B are screen displays of the user interface in an embodiment of client 104, where the client is used for performing management and analysis of financial information. Referring to FIG. 6, in one embodiment, client software 106 running on client 104 may include a work area 600 provided by the system. Work area 600 may include one or more function modules. Work areas provide users with a dashboard component that consolidates navigation to research tools such as source documents, research documents, newsfeeds, analysis, XBRL data, and links organized by portfolios and tickers, which provide a user at client 104 with live data relating to financial information. In the embodiment shown, work area 600 includes RSS newsfeed module 610, links module 620, source documents module 630, and research module 640. Selection of the source documents module 630 tab displays the available source documents for the active project, and selection of the research module 640 tab displays the available research documents for the active project. Project name 650 indicates the active project currently displayed to the user. In this example, the project is the “Amazon” portfolio and the terms “project” and “portfolio” may be used interchangeably, but the term “project” may refer to any subject matter being researched. In the example work area 600 of FIG. 6, the project name 650 indicates the current portfolio of Amazon, but in other examples the project name may indicate any suitable research topic desired by the user. In the Amazon project example shown in work area 600, the analyst is researching a single stock, namely Amazon.com (AMZN), and work area 600 displays an inventory 660 of available topics from RSS newsfeed 610, in this case links to RSS newsfeed items relating to Amazon.com (AMZN) and competitors Best Buy Co., Inc. (BBY), Costco Wholesale Corp. (COST), and Target Corp. (TGT).

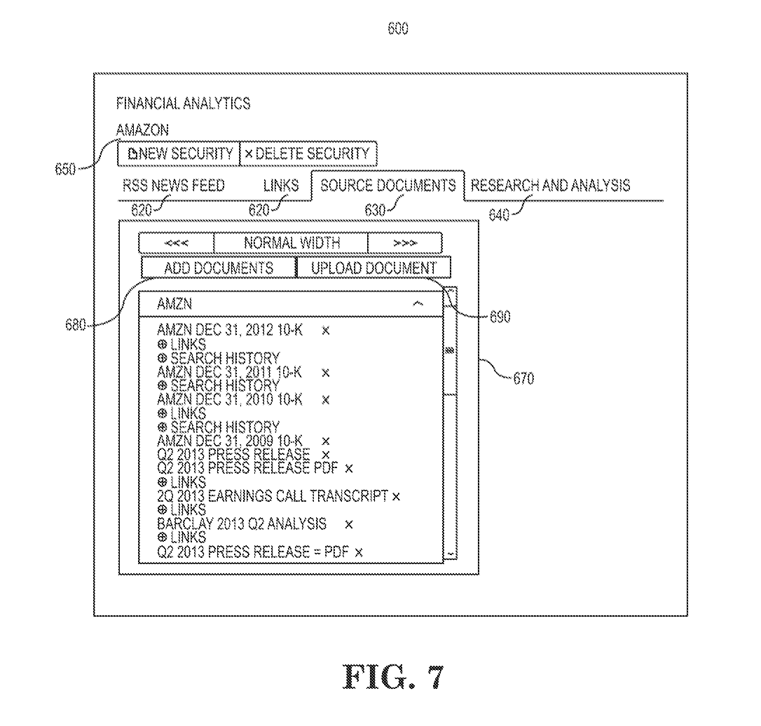

Referring to FIG. 7, another view of work area 600 is shown, where source documents module 630 has been selected and source document inventory 670 is displayed, showing source documents relating to the Amazon.com project that are available to the user. In source document inventory 670, any relevant research information, such as links and prior user searches, are organized by security and document. Source document inventory 670 may also include saved search results from any users, as well as automatic links to source documents and precise location within those source documents, viewed in prior research sessions of the same user or different users. A user may initiate the process of adding a source document to the system, e.g., by importing the file as described in steps 340-380 or by importing the data from an XBRL instance as described in steps 455-475, by selecting the add documents button 680. Similarly, a user may initiate the process of uploading a source document to the system, e.g., by uploading the file as described in steps 310-330, by selecting the upload documents button 690. Once a new document is added to the system, the system will display it in source document inventory 670.

In operation, work area 600, allows users to manually retrieve a variety of desired information. For example, a user may search corporate ticker symbols, responsive to which the system searches live data from a plurality or sources, including RSS newsfeeds, XBRL database 270 and other public SEC feeds, and any other suitable source, and then the system retrieves and displays the relevant results to the user in work area 600. For example, the user may search ‘AMZN’ and receive the results displayed in source document inventory 670. The search results include embedded hyperlinks that point to the original document, which are retrieved and displayed to the user upon a single click of the desired result. The system tracks users' sessions, including which documents are viewed by the users and which sections of the documents were viewed; e.g., lines, paragraphs, tables, footnotes, and the like. Work area 600 also displays an indicia that indicates which, if any, of the displayed documents results have been viewed previously by another researcher and, more specifically, which particular section or sections were viewed (e.g., work area 600 displays to the user that a previous researcher viewed a footnote in the ‘AMZN Dec. 31, 2012 10-K’ document, and displays a link pointing precisely to that footnote in the document). Such search history data, links, and other metadata relating to source documents and research documents are stored in relational database 260. User authorizations to view such metadata may be set by portfolio, by project, by group, by user, by document or file, or by any other suitable construct.

During a research session, the user may search for or identify specific documents for inclusion in the system as source documents 280. Such documents may already be a source document 280, for example because the current user or another user already imported the document and the system created a copy in storage unit 250, or because the system automatically imported the document into storage unit 250. The system is configured to retrieve results from relevant sources pertaining to the research subject matter, and in this example the search results include links to multiple sources, including a news feed and an SEC RSS feed. Upon user selection of the desired link, if the subject document has not already been imported as a source document, the system automatically retrieves and creates a copy of the document in the system. The system also allows the user to enter a direct link to a known document to be imported. For example, the user may view the investor relations section of the Amazon.com website and locate a desired document, such as 10-K filings, press releases, earnings releases, reports, call transcripts, and the like. The user also may locate other helpful documents, such as a report on retailers or other research. Once the user identifies the location of the desired document the user may enter the link to the document into the system for document retrieval. The system further assists the user in performing queries for additional documents. For example, with a single click, the system may perform an Internet search for ‘AMZN investor relations,’ which is predispose to return a link to the investor relations section of the Amazon.com website, and the user can locate the desired document link and enter it into the system for document retrieval. As described, the system is configured to import, process, and convert any suitable file format; e.g., Microsoft Office format, PDF files, HTML files, text files, CSV, and other spreadsheets. In this example, the system converts the retrieved files into HTML, but other formats may be employed in accordance with the invention.

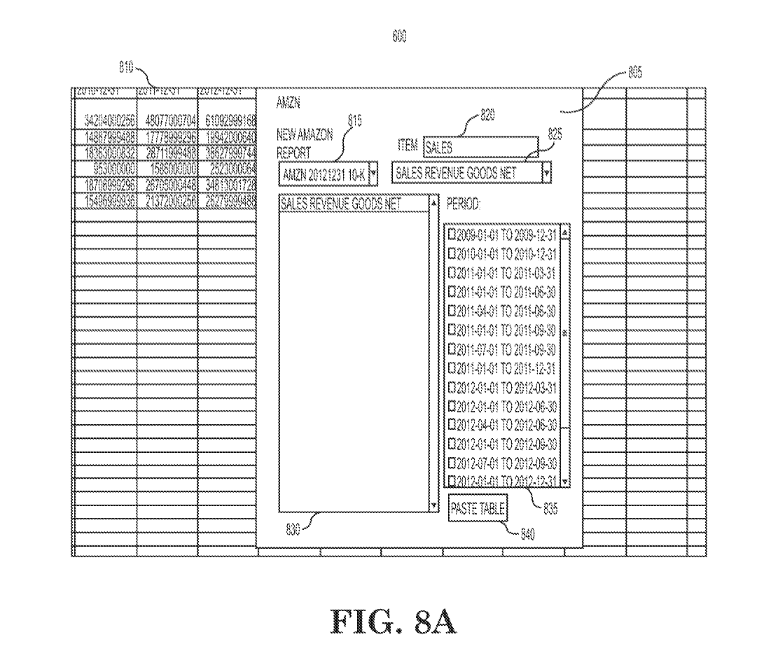

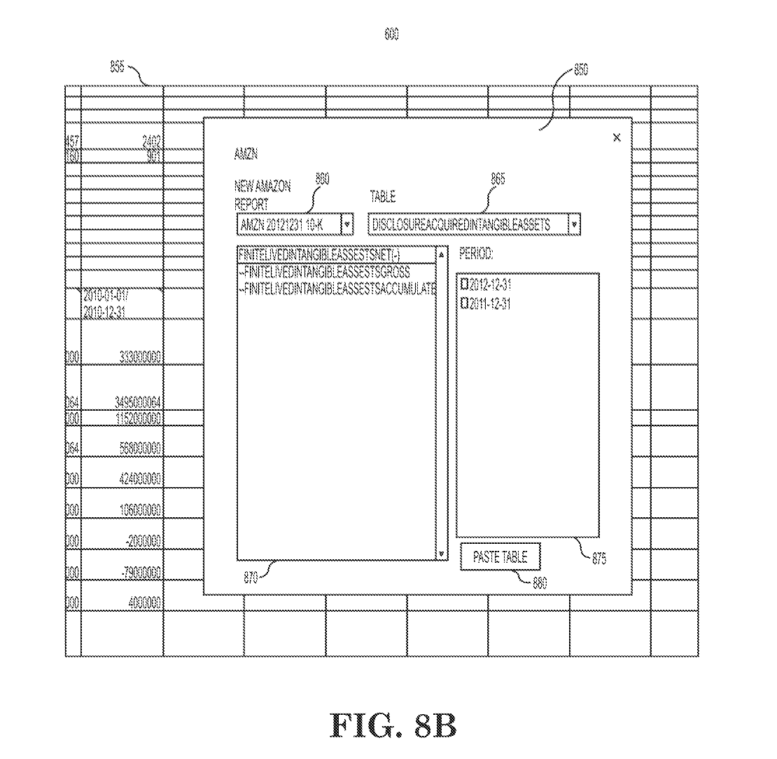

As described, a user may import or copy/paste XBRL data into an appropriate suitable research document such as a spreadsheet. Referring to FIG. 8A, upon appropriate user selection, the system retrieves and displays available XBRL data 805 that is related to the current project, and work area 600 prompts the user to select from the available data. For example, work area 600 may prompt the user with available XBRL data 805 relating to the current project, Amazon.com, and the user may select from the data displayed. For the current project, drop-down box 815 may provide the user with various SEC filings reported by Amazon.com in XBRL format, retrieved by the system from XBRL database 270. As shown, the user selects the 10-K reports filed by Amazon.com from drop-down box 815, and the system further narrows the results responsive to the user's entry of “sales” in query box 820, the user's selection of “Sales Revenue Goods Net” from drop-down box 825, and the user's selection from results pane 830. The user's selections are received by the system, and responsive to the user's selections, the system displays the returned reports in selection pane 835. The user may then select the boxes adjacent to the desired results in selection pane 835 and select “paste table” button 840. Responsive to such selections by the user, the system retrieves the identified XBRL data, processes the data with the predetermined XML syntax, and directly imports the processed XBRL data into a source document, such as a spreadsheet 810 or other suitable document type.

The system also allows users to retrieve XBRL data even when direct selection and importation from XBRL data into spreadsheets is not possible, for example, by directly pasting XBRL data into spreadsheets. Referring to FIG. 8B, upon appropriate user selection, the system retrieves and displays available XBRL data 850 that is related to the current project, and work area 600 prompts the user to select from the available data. For example, work area 600 may prompt the user with the available XBRL data 850 relating to the current project, Amazon.com, and the user may select from the data displayed. For the current project, drop-down box 860 may provide the user with various SEC filings reported by Amazon.com in XBRL format, retrieved by the system from XBRL database 270. As shown, the user selects the 10-K reports filed by Amazon.com from drop-down box 860, and the system further narrows the results responsive to the user's selection of “Disclosure Acquired Intangible Assets” from drop-down box 865 and the user's selection from results pane 870. The user's selections are received by the system, and responsive to the user's selections the system displays the returned reports in selection pane 875. The user may then select the boxes adjacent to the desired results in selection pane 875 and select “paste table” button 880. Responsive to such selections by the user, the system copies the identified XBRL data into memory, processes the data with the predetermined XML syntax, and directly pastes the copied XBRL data into spreadsheet 855 or other suitable document type.

The system retrieves and maintains a metadata repository in XBRL database 270, within the system and server 110, by regularly accessing the SEC site, or other suitable source, for XBRL data retrieval and updating the XBRL database 270 with live data. By retrieving, processing, and locally storing XBRL data, the system allows for the creation of XBRL data definitions, which provides users with faster and more reliable access to XBRL data. Additionally, the intake and processing of XBRL data allows the system to expose the XBRL data to the user within a web browser, or other suitable user interface, in a format that is readily copied and pasted into a spreadsheet. The module allows the user to select and retrieve XBRL data items, either by importing or copying/pasting. For example, the user may select a desired ticker, select a frequency (e.g., 12 months, 3 months, 6 months, or 9 months), and/or enter a keyword for searching. The system receives the user input and retrieves and displays a data availability table that displays results having matching labels, availability, and values. For example, if a user enters (i) ‘AMZN’ for the ticker, (ii) 12 months for frequency, and ‘Sales’ for the keyword, the availability table may display the data shown in Table 1. The user may select and copy any portion of the displayed table and then paste it into a spreadsheet for research.

TABLE 1

| Label | Dec. 31, 2007 | Dec. 31, 2008 | Dec. 31, 2009 | Dec. 31, 2010 | Dec. 31, 2011 | Dec. 31, 2013 |
|---|---|---|---|---|---|---|
| Sales Revenue | | | 22,272,999 | 30,791,999 | 41,999,999 | 51,733,000 |
| Goods Net | | | | | | |
| Sales Revenue, | | | 24,508,999 | 34,204,000 | 48,077,000 | 61,092,999 |
| Net | | | | | | |
| Sales Revenue | | | 2,236,000 | 3,412,000 | 6,077,000 | 9,360,000 |
| Services Net | | | | | | |
| Sales Revenue, | | 19,165,999 | 24,508,999 | 34,204,000 | | |
| Net | | | | | | |
| Net Sales | 14,835,000 | 19,165,999 | 24,508,999 | | | |

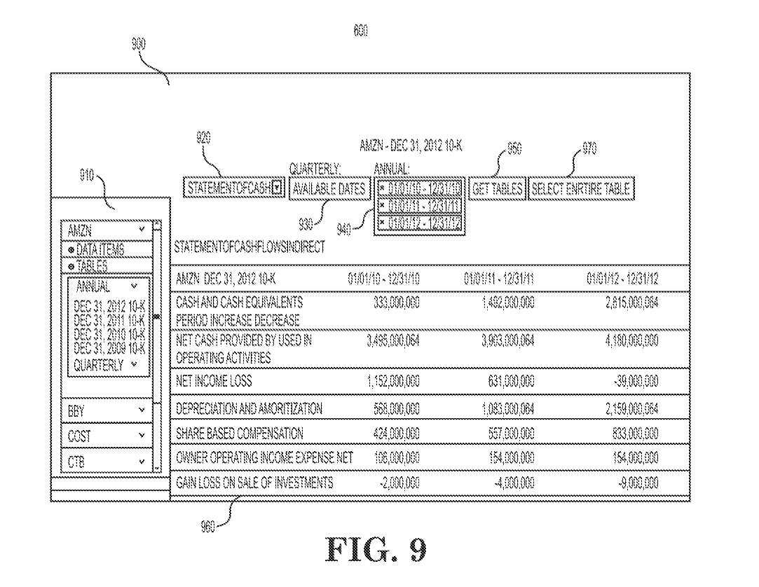

In operation, the system may provide the user with the ability to create accurate data dictionaries with XBRL data. For example, in certain research scenarios a company's XBRL 2009 10-K filing may be preferable to the 2010 10-K filing, and the system provides to user the option to decide and select the desired filing, thereby allowing the user to generate correct data dictionaries and filter out bad data by not selecting it. The data availability table may also include attendant drop-down boxes, providing for additional user input and selection: (i) a “primary data label” drop-down box for user selection of the desired variable, (ii) an “append data” drop-down box for appending data that are not in the primary series, and (iii) and an “append and replace data” drop-down box for appending data not in the primary series and replacing data present in the primary series. Upon user selection of a “paste” button, the system populates the spreadsheet in accordance with the user's selections, and the user may expand or collapse the detail. The data availability table may remain displayed until the user closes it or searches another keyword. As long as the table is displayed, users may continue using the data availability table to populate the data item table. The system provides the user with an option to append a ticker in the far left-hand column, indicating the corresponding company, and the user may insert comments in cells like the script. The system may default to data definitions in drop down menus below the data availability table, but the system also provides the user with the option to save data definitions, which the user can quickly construct and reconstruct as desired. The system may employ the use of colors to highlight data definitions in the availability table upon selection. Referring to FIG. 9, work area 600 displays an XBRL data item selection module, which is available to the user for filtering and selecting XBRL data stored within the system and server 110. Availability table 910 displays the available data items and tables, and frequency, for the user's selection for the chosen ticker. Report type drop-down 920, and date widgets 930 and 940, allow the user to further refine the available data items and tables displayed to the user, and “get table” button 950 instructs the system to retrieve the table data matching the user's selections. Table data 960 is displayed to the user and is readily selected by the user, either with the “select entire table” button 970 or by the user selecting specific cells/columns/rows from the data. Once the desired data is selected, it is readily copied and pasted into a spreadsheet for research.

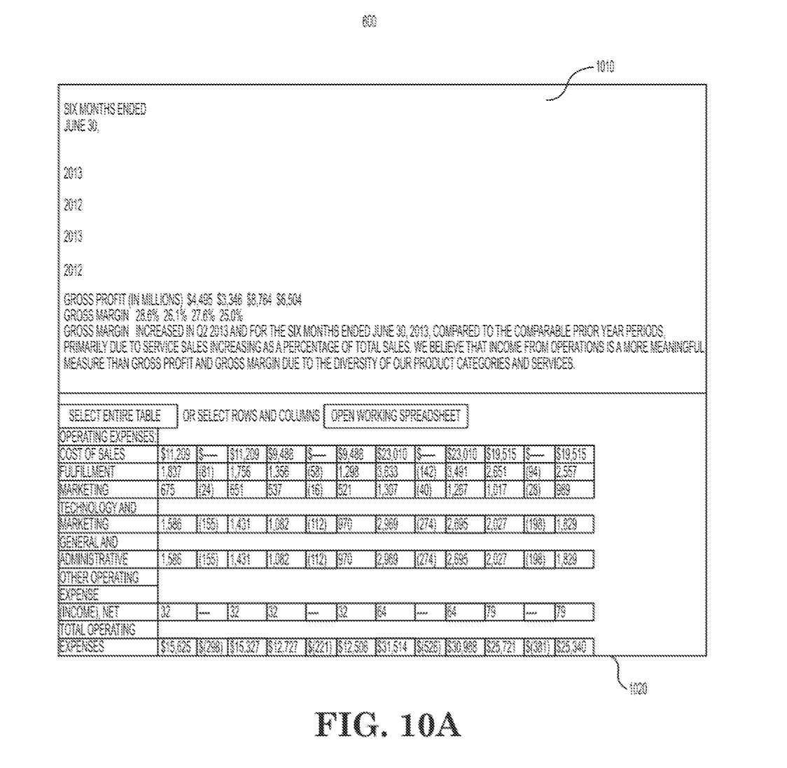

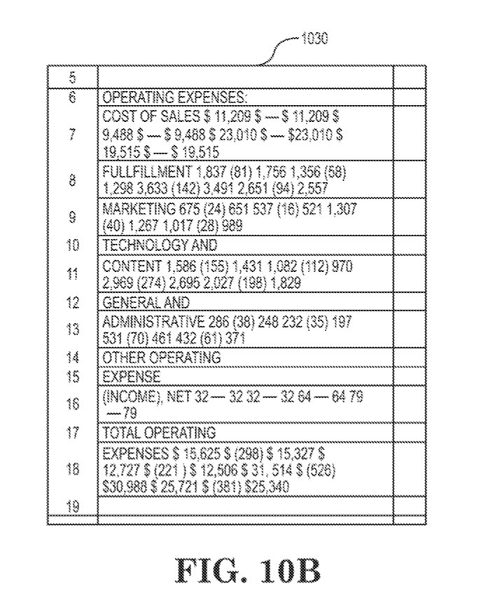

The system is configured to copy table data directly from PDF files and directly paste the data, with appropriate formatting modifications, into a spreadsheet or discussion document 290. Referring to FIG. 10A, work area 600 displays a table 1010 from an original PDF source document 280. As described herein, the system provides spreadsheet tools that allow the user to efficiently copy and paste the table 1010 from a source document 280, such as a PDF file, and directly paste the selected table data into research document 290, such as spreadsheet 1020, while properly rendering and formatting the various components of the PDF table to maintain the integrity, visual accuracy, and alignment of the table data. The system processing of table 1010 thereby allows the user to directly paste the data into spreadsheet 1020. The data displayed in spreadsheet 1020 maintains data from table 1010 across the columns and rows, while accurately processing formatting idiosyncrasies such as footnotes/endnotes and space delineators from table 1010. In contrast, without the spreadsheet tools and system processing, direct copying of the same data from table 1010 in the PDF file and pasting that data into a spreadsheet yields improper and misaligned data from table 1010 being pasted and displayed, as shown in spreadsheet 1030 in FIG. 10B.

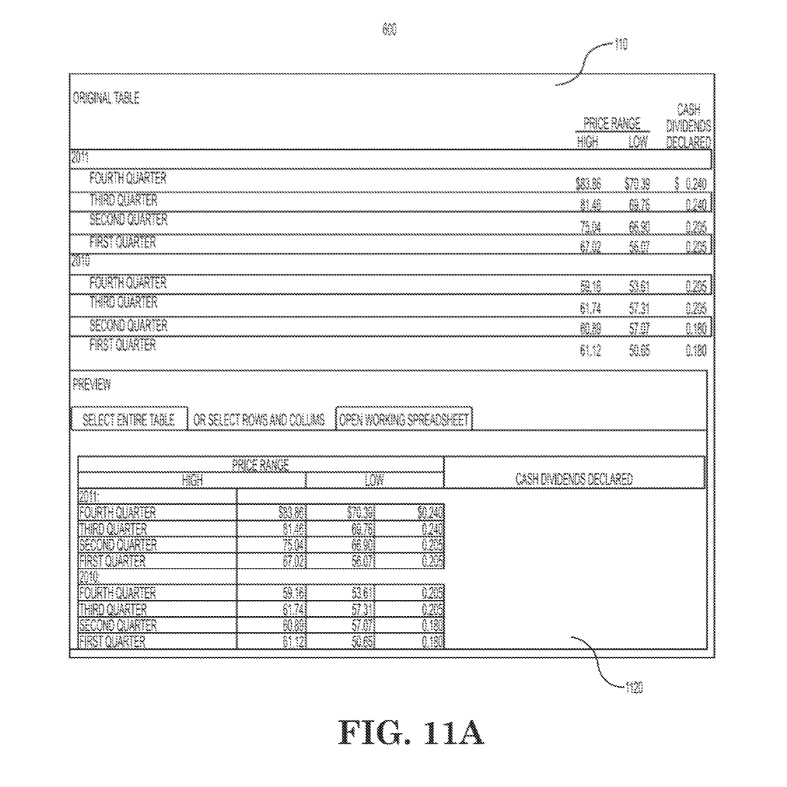

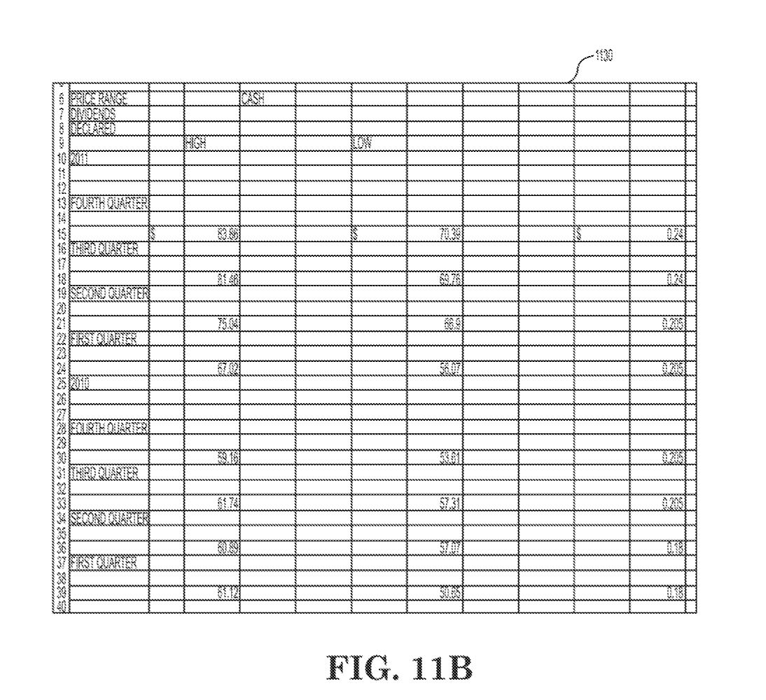

The system is configured to copy table data directly from HTML files and directly paste the data, with appropriate formatting modifications, into a spreadsheet or discussion document 290. Referring to FIG. 11A, work area 600 displays a table 1110 from an original HTML source document 280. As described herein, the system provides spreadsheet tools that allow the user to efficiently copy and paste the table 1110 from a source document 280, such as an HTML file, and directly paste the selected table data into research document 290, such as spreadsheet 1120, while properly rendering and formatting the various components of the HTML table to maintain the integrity, visual accuracy, and alignment of the table data. The system processing of table 1110 thereby allows the user to directly paste the data into spreadsheet 1120. The data displayed in spreadsheet 1120 maintains data from table 1110 across the columns and rows, while accurately processing formatting idiosyncrasies such as footnotes/endnotes and extra rows for years from table 1110. In contrast, without the spreadsheet tools and system processing, direct copying of the same data from table 1110 in the HTML file and pasting that data into a spreadsheet yields improper and misaligned data from table 1110 being pasted and displayed, as shown in spreadsheet 1130 in FIG. 11B.

The foregoing examples describe the system copying table data directly from PDF files and HTML files, and directly pasting the data into a spreadsheet while maintaining the table data in a usable format, but the system may also copy and paste table data originating from other suitable source document formats, including XBRL data, XML data, and the like. The spreadsheet that receives the pasted table data may be any suitable spreadsheet format. In one example, the spreadsheet is a Google Docs Spreadsheet that is stored in storage unit 280, and when pasting the table data, the system automatically processes the data. For example, as necessary the system rotates the source document, aligns data in the same column, aligns data in the same row, and processes footnotes to avoid misalignment of cells.

The system provides a variety of spreadsheet tools to manipulate and transform table data retrieved from any suitable source, including newsfeeds, HTML files, PDF files, XBRL data, and the like. Such tools facilitate table data processing, particularly for table data that is not automatically formatted or useable when copying and pasting. For example, the spreadsheet tools allow the system to recognize columns, rows, and footnotes in a table and, if proper formatting of the table is not parsed by the system, the system will prompt the user for additional information. Such additional information may include the number of rows and columns in the table, the specific rows/columns/cells to be selected for copying, footnote style (e.g., “note” or “note #”), and the largest footnote number appearing in the table. These tools allow the system to process and paste the data properly into a useable format. For example, if the user indicates that the footnote style is “note #,” the system will identify footnotes in the data and then append the following footnote text at the end of a table, rather than bumping the cell over a column, which would result in improper formatting of the data in the spreadsheet. In another example, if the user indicates that the largest footnote appearing in the table is ‘20,’ then the system will disregard higher numbers when processing for footnotes. The system also stores a predetermined threshold number (e.g., 30,000), above which it disregards when processing for footnotes because such large numbers are rarely used for footnote numbers. The predetermined number is adjustable by the user.

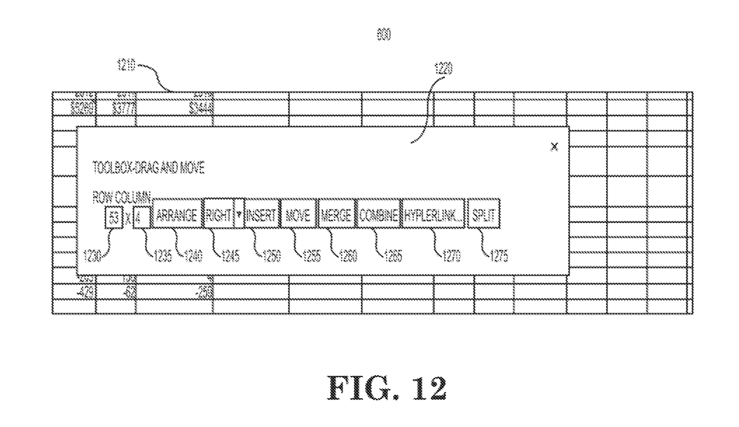

Referring to FIG. 12, work area 600 displays a table 1210 containing table data copied from a suitable source document, and toolbox 1220 that facilitates transformation of the data to be pasted or otherwise imported or inserted into the spreadsheet/research document 290 containing table 1210. When the system contains the rules and syntax necessary to transform the copied table data into a format that allows for direct pasting into a spreadsheet/research document, the system directly pastes the data. When table data that cannot be parsed is imported to the system, spreadsheet tools are available for user-assisted formatting of the data to process such data. For example, dialogue toolbox 1220 is displayed to the user to allow the user to direct the system for proper rendering of the copied table data. Row selection text box 1230 and column selection text box 1235 are objects through which the system receives user input specifically identifying which row/column of data is selected for the subsequent processing. Justification arrangement button 1240 and justification drop-down box 1245 are objects through which the system receives user selection of the justification for the selected row/column of data in the spreadsheet/research document. Selection of the insert button 1250 object by the user causes the system to insert cell(s), row(s), or columns(s), dependent upon the selected row/column of data, into the spreadsheet/research document responsive to the user's request. Selection of the move dialogue button 1255 object by the user causes the system to initiate the move-and-drag functionality, prompting the user with a query box for receiving user input indicating the direction and distance on the spreadsheet/research document the system will move the selected row/column of data. Selection of the merge button 1260 object or the combine button 1265 object by the user causes the system to merge the cells or combine the data of the selected rows/columns in the spreadsheet/research document. Selection of the split dialogue button 1275 object by the user causes the system to prompt the user to define the number or rows, columns, or cells into which the selected rows/columns will be split in the spreadsheet/research document. Selection of the hyperlink button 1270 object causes the system to prompt the user with a query box for receiving a hyperlink, or other suitable link or pointer, from the user corresponding to a relevant source document, such as the document from which the table data originated. The system correlates the selected rows/columns with the hyperlink received from the user and stores the correlation in relational database 260 in the record associated with the spreadsheet/research document.

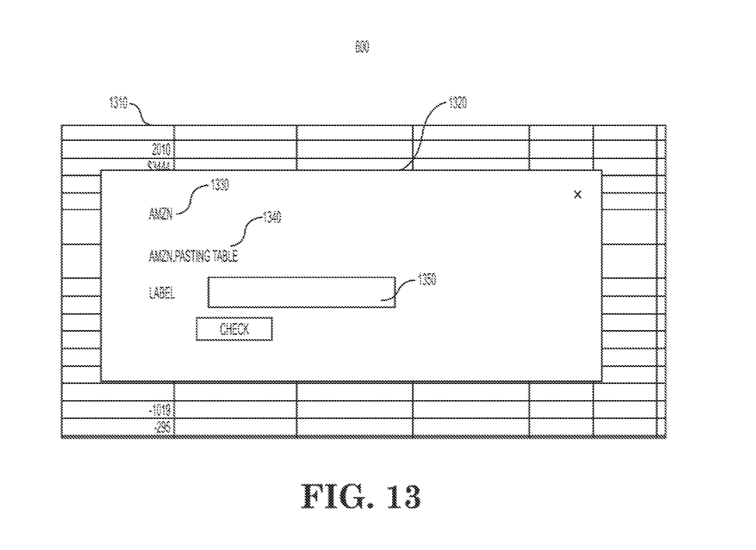

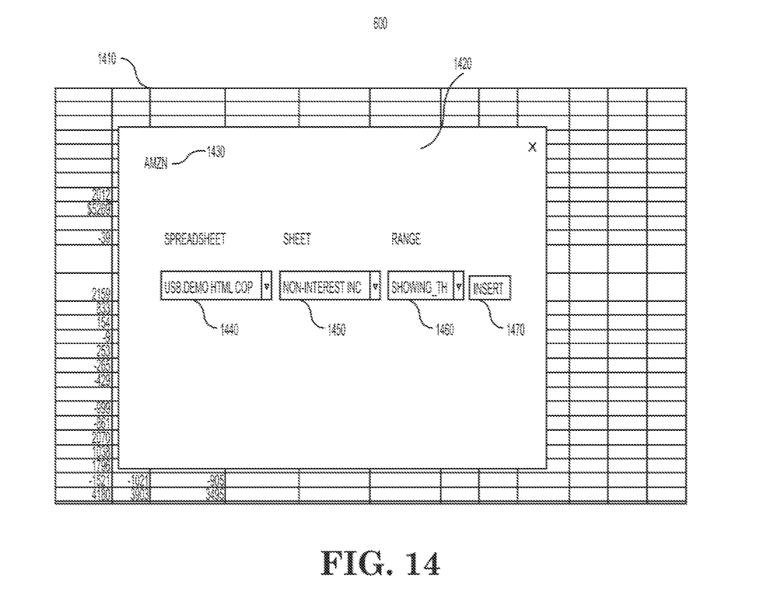

The system spreadsheet tools also manipulate and transform table data retrieved from any suitable source with the creation of data labels to facilitate the efficient and secure sharing of data across spreadsheets, projects, portfolios, and users. Referring to FIG. 13, work area 600 displays a spreadsheet 1310 and toolbox 1320 that displays a project name 1330 and a spreadsheet name 1340 of spreadsheet 1310. The user may enter and submit a label name in text box 1350, which is received by the system from the user, and the system associates the received label with the spreadsheet 1320 and stores the association in relational database 260. Data labels allow for efficient sharing and transformation for spreadsheets and data from multiple users. Referring to FIG. 14, work area 600 displays a spreadsheet 1410 and toolbox 1420 that displays a project name 1430 of the user's active project. The system maintains security provisions in relational database 260, for example by allowing users with permission to the AMZN project 1430 write access to specified spreadsheets and sheets within that project. In the example shown in FIG. 14, a user researching within the AMZN project 1430 is granted write access to a plurality of spreadsheets, which work area 600 makes available for user selection from drop-down boxes 1440 and 1450. The user may select the desired spreadsheet and sheet combination from drop-down boxes 1440 and 1450 and select the desired range of cells/rows/columns from spreadsheet 1410 from drop-down box 1460. Then, responsive to the user's selection of the insert button 1470, the system inserts the selected range of cells/rows/columns from spreadsheet 1410 into the spreadsheet and sheet combination indicated by the user in from drop-down boxes 1440 and 1450. The employment of labels allows users to readily import table data, and other information, readily across spreadsheets, projects, portfolios, and users.

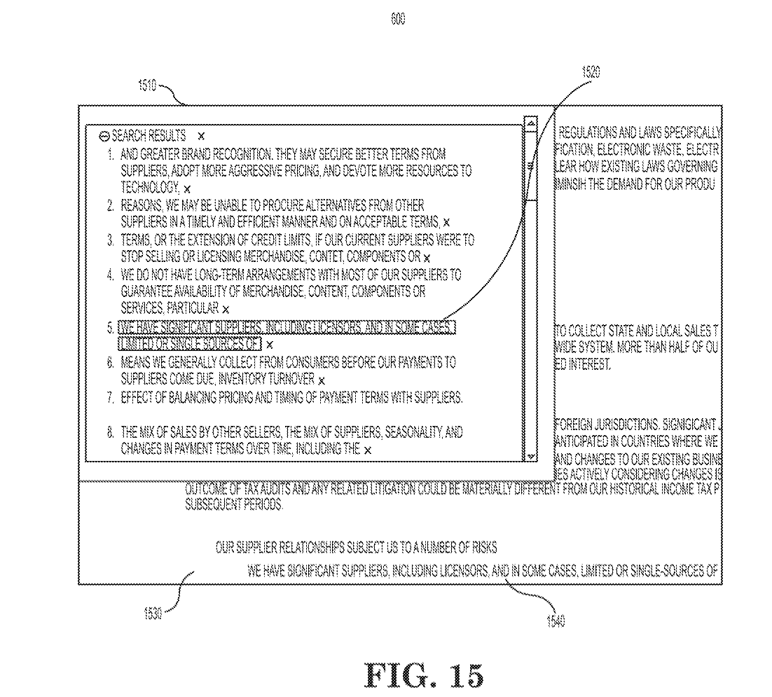

As describe herein, the system automatically tracks users' research activities, such as search strings, source document views, research document manipulation, and the like. Based on the user tracking, the system automatically creates links, stored in relational database 260, from research/discussion documents 290 to the specific location in the originating document, such as source document 280 or XBRL record 270, or to the specific location in the original source document or research document that supports the user's comments or research conclusions. Referring to FIG. 15, an example screen display is shown of work area 600 displaying a research/discussion document 1510, containing a research analyst's comments. In this example, as the research analyst views source documents 280 and enters relevant analysis and discussion into research document 1510, the system automatically and/or manually create links, which are stored in relational database 260, between the comments in the discussion document and the specific locations in the source document(s) 280 that contain the information or data that was relied upon by the user in support of the user's discussion or conclusions. For example, the research analyst reviewed source document 1530, and entered a comment 1520 into research document 1510 based on the source document's contents. The system automatically tracked the user's activity and automatically created a link, which is stored in relational database 260, between the comment 1520 and the specific location 1540 in the source document 1530 relied upon. The same research analyst, or any subsequent user with permissions to the same project or portfolio as the research document 1510, may later view the analyst's comments in the discussion document and retrieve the source document 1530 and the specific section 1540 of that document that supported the research with a single click on the comment 1520.

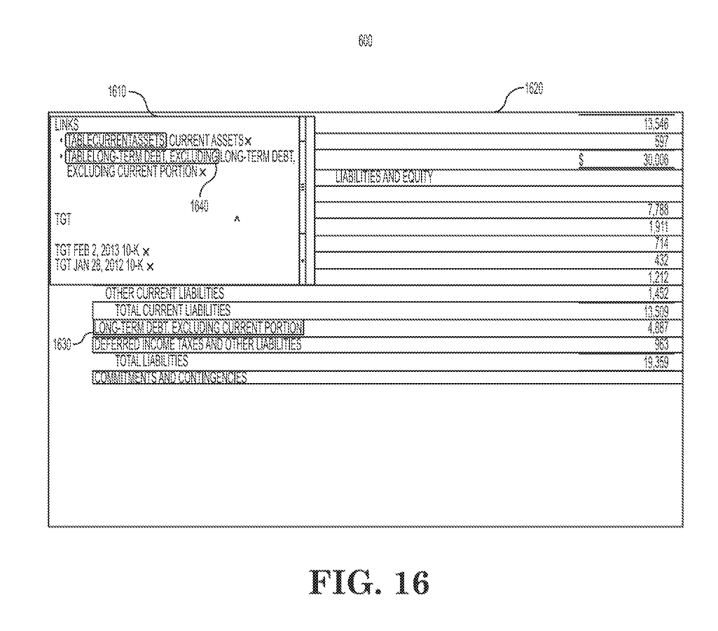

The system is configured to automatically format and store links to source documents when users import and copy table data and other relevant research information from source documents and paste it into spreadsheets and other research documents. Referring to FIG. 16, an example screen display is shown of work area 600 displaying a research/discussion document 1610, containing a research analyst's pastings of live financial information relating to Target Corp. (TGT). In this example, the research analyst viewed and analyzed a table in HTML source document 1620 and copied the line item 1630, “LONG-TERM DEBT, excluding current portfolio,” from the HTML document and pasted it into discussion document 1610. The system automatically tracked the user action, and created an entry in relational database 260 associating the entry 1640 in discussion document 1610 with the specific source item 1630 in the originating table in HTML source document 1620. When the same research analyst, or any subsequent user with permissions to the same project or portfolio as the research document 1610, views the analyst's entry 1640, the system will retrieve and display the specific location 1630 in the source document 1620 responsive to the user's selection of or click on the entry 1640.

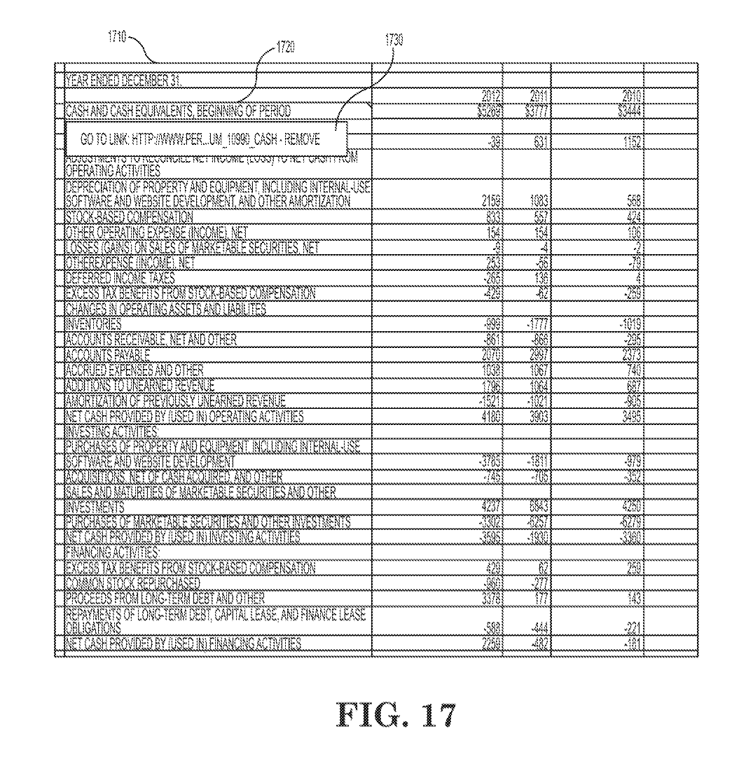

Similarly, when the research analyst selects and copies data from a table in an HTML source document, and then pastes the data into a research document spreadsheet, the system automatically formats the data into the research document spreadsheet and automatically generates a link in relational database 260 associating pasted data in the research document spreadsheet with the specific source item in the originating table in the HTML source document from which the data was copied. For example, referring to FIG. 17, an example screen display is shown of research document spreadsheet 1710, into which a research analyst pasted data copied from a live data HTML source document, and the system automatically formatted the data into document 1710 for proper display, maintaining the accurate formatting. In addition to pasting the data into document 1710, the system also automatically creates a link in relational database 260 associating pasted data in the research document spreadsheet with the specific source item in the originating table in HTML source document from which the data was copied. The associations created and maintained in relational database 260 associate down to the cell-level, e.g., cell 1720 is specifically correlated with a hyperlink 1730, which points to the originating cell from the source document. When to users with appropriate permissions subsequently view spreadsheet 1710, the system displays both the formatted data in the spreadsheet that was pasted from the source document and the selectable link 1730 pointing to the originating HTML source document. A user may retrieve and view the originating HTML source document, and immediately view the table in the source document, with a single click of link 1730 or other selection action.

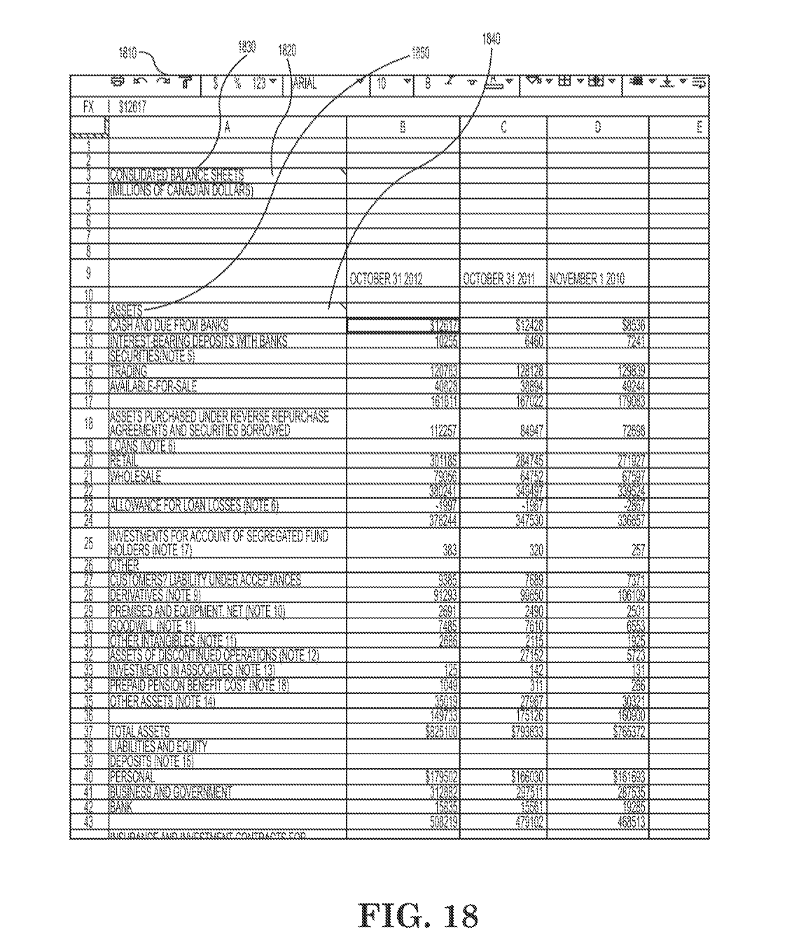

The system is also configured so that when a research analyst selects and copies data from a table in a PDF source document, and then pastes the data into a research document spreadsheet, the system automatically formats the data into the research document spreadsheet and automatically creates a link in relational database 260 associating the pasted data in the research document spreadsheet with the specific source object in the originating table in the PDF source document from which the data was copied. For example, referring to FIG. 18, an example screen display is shown of research document spreadsheet 1810, into which a research analyst pasted data copied from a live data PDF source report filed by the Royal Bank of Canada, and the system automatically formatted the data into document 1810 for proper display, maintaining the accurate formatting. In addition to pasting the data into document 1810, the system also automatically creates a link in relational database 260 associating pasted data in the research document spreadsheet with the specific source item in the originating table in PDF source document from which the data was copied. The associations created and maintained in relational database 260 associate down to the cell-level, e.g., cell 1820 is specifically correlated with a hyperlink 1830 and cell 1840 is specifically correlated with a hyperlink 1850, which point to their originating cells from the source document respectively. When a user subsequently views spreadsheet 1810 the system displays, to users with appropriate permissions, both the formatted data in the spreadsheet that was pasted from the source document and the selectable links 1830, 1850 pointing to the originating PDF source document. A user may retrieve and view the originating source PDF document with a single click of link 1830, 1850 or other selection action.

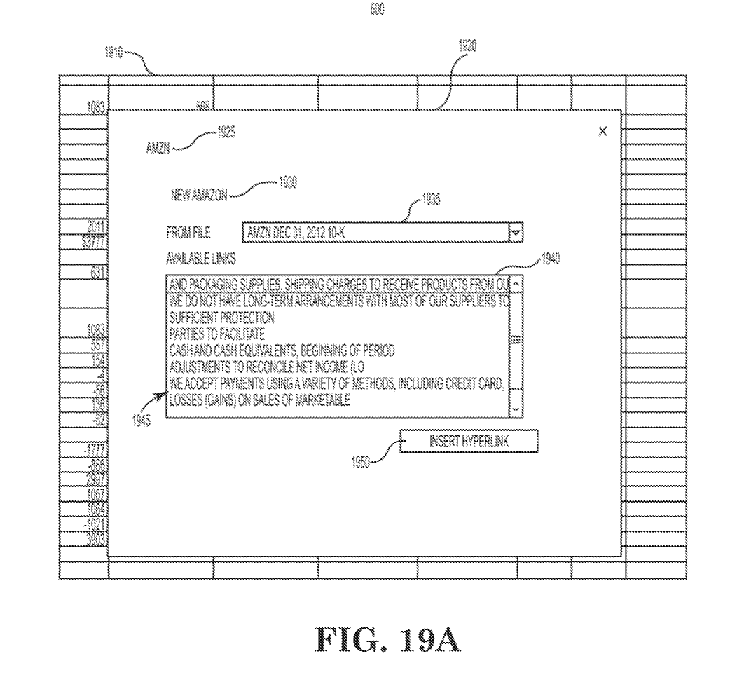

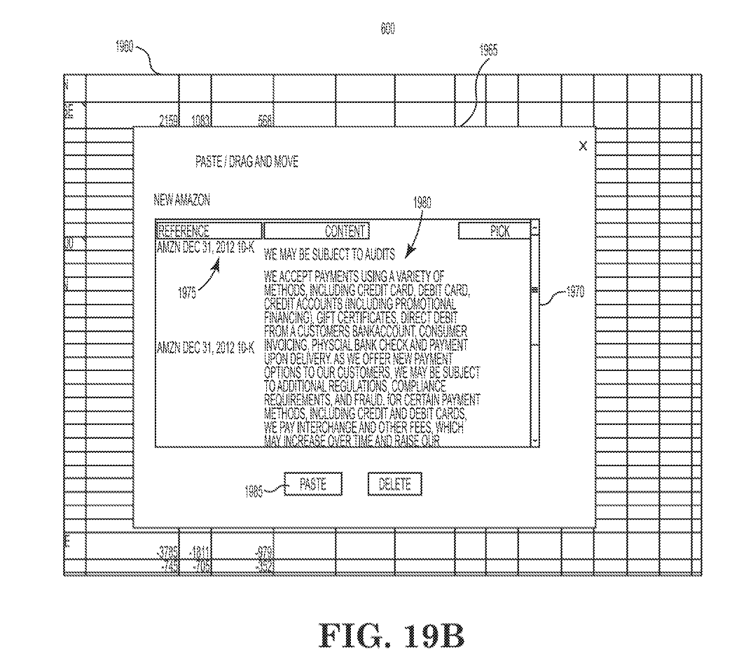

The system allows users to select specific objects or text within a research document and create a link to that location corresponding to a precise, user-selected location within a source documents. This functionality may be useful when the system does not generate such a link automatically. Referring to FIG. 19A, work area 600 displays research document spreadsheet 1910. In this example, the user creates a link from research document spreadsheet 1910 to a specified location in a user-selected source document. The user may initiate this process by selecting text or a cell in research document spreadsheet 1910 and opening display toolbox 1920. The work area displays toolbox 1920 to allow the user to select and insert a precise link into spreadsheet 1910. The toolbox 1920 displays a project name 1925 of the user's active project and a spreadsheet name 1930 of spreadsheet 1910. The user may select a desired source document from drop-down box 1935, and in this example the user selects the 2012 10-K Annual Report filed by Amazon.com, Inc. (AMZN) with the SEC. The system receives the user's selection in drop-down box 1935 and displays text of the available links, which may be stored in relational database 260, from the selected source document in pane 1940. The system generates the available links by scanning clauses, text strings, and other objects in the source document and returns the suitable results in pane 1940. The user may select the text of the desired link in pane 1940, and in this example the user selects text 1945, “We accept payments using a variety of methods, including credit cards . . . ” The user then selects the insert hyperlink button 1950 and the system inserts a link to the specific location in the source document in drop-down box 1935 that corresponds to the text 1945.

The system also allows the user to select and insert automatically generated links from source documents. Referring to FIG. 19B, work area 600 displays research document spreadsheet 1960. In this example, the system automatically identified suitable links for the user's selection, available for pasting and insertion into the spreadsheet 1960. The user may initiate this process by selecting text or a cell in research document spreadsheet 1960 and opening display toolbox 1965. The work area displays toolbox 1965, populated with automatically generated links in pane 1970 that are available for the user's selection. Pane 1970 displays both the source document name 1975 and the text 1980 corresponding to the location in the source document to which link points. The user's selection of the text 1980, and selection of the paste button 1985, causes the system to paste or insert a precise link into spreadsheet 1960 that points to the specific location in the source document 1975 that corresponds to the text 1980. Work area 600 will display to subsequent users the selected location in spreadsheet 1960 accompanied with the link inserted that points to precise location in the source document.

Various changes and modifications to the disclosed embodiments described herein will be apparent to those skilled in the art. Such changes and modifications can be made without departing from the spirit and scope of the present subject matter and without diminishing its intended advantages. Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a device (e.g., a computer or other processor-driven display device). For example, a machine-readable storage device may include read-only memory (ROM), random-access memory (RAM), magnetic disk storage media, optical storage media, flash-memory devices, and other storage devices and media. In some embodiments, display devices such as televisions, A/V receivers, set-top boxes, and media players may include one or more processors and may be configured with instructions stored on such machine-readable storage devices.

What is claimed is:

1. A computer-implemented method for facilitating financial data management and analysis, the method comprising:
receiving a financial data object, said financial data object having a first file format;
causing at least one processor device to process said financial data object, including reading an information object from said financial data object, said information object containing data, and parsing said data from said financial data object;
causing the at least one processor device to convert said financial data object from a first file format into a second file format;
storing said parsed data from the financial data object in at least one storage device, wherein said parsed data is stored in said second format; and
causing the at least one processor device to generate a link associating said parsed data with said financial data object.

2. The method of claim 1, wherein said second file format is distinct from said first file format.

3. The method of claim 1, wherein said financial data object is a data file comprising at least one of an SEC Form-10K, SEC Form 10-Q, SEC Form S-1, and proxy statement.

4. The method of claim 1 wherein said financial data object is received from an internet.

5. The method of claim 1, wherein said financial data object is a data file in HTML format or PDF format.

6. The method of claim 5, wherein said information object is a data table stored in said HTML data file or PDF data file.

7. The method of claim 6:
wherein parsing said data from the data table comprises:
recognizing formatting, including footnotes, contained in said data table; and
repositioning said recognized footnotes in said data table; and
wherein storing said parsed data comprises storing said repositioned footnotes in said data table in the second format such that said data from the table data is aligned.

8. The method of claim 1, wherein the financial data object includes data in XBRL format.

9. The method of claim 8, wherein:
said financial data object is received from a database containing data expressed in accordance with an XBRL standard; and
said at least one processor device is configured to repeatedly perform the steps of:
determining available XBRL data from a public server;
comparing said available XBRL data with said data in the database to determine new XBRL data from the public server;
retrieving said new XBRL data from the public server; and storing said new XBRL data in the database.

10. A non-transitory computer-readable medium, including at least computer program code stored thereon, for facilitating financial data management and analysis, comprising:
computer program code for receiving a financial data object, said financial data object having a first file format;
computer program code for causing at least one processor device to process said financial data object, including reading an information object from said financial data object, said information object containing data, and parsing said data from said financial data object;
computer program code for causing the at least one processor device to convert said financial data object from a first file format into a second file format;
computer program code for storing said parsed data from the financial data object in at least one storage device, wherein said parsed data is stored in said second format; and
computer program code for causing the at least one processor device to generate a link associating said parsed data with said financial data object.

11. A financial data management and analysis system, said system comprising:
a server for receiving a financial data object, said financial data object having a first file format;
a processor device configured to (i) process said financial data object, including reading an information object from said financial data object, said information object containing data, and parsing said data from said financial data object; (ii) convert said financial data object from a first file format into a second file format; and (iii) generate a link associating said parsed data with said financial data object; and
a storage unit for storing (i) said parsed data from the financial data object, wherein said parsed data is stored in said second format.
